(19) United States
(12) Patent Application Publication
(10) Pub. No.: US 2014/0115969 A1
(43) Pub. Date: May 1, 2014

(54) SHOWER DOOR PULLEY DEVICE

(71) Applicant: FOSHAN IDEAL CO., LTD., Foshan (CN)

(72) Inventor: Wuxiang WEI, Foshan (CN)

(73) Assignee: FOSHAN IDEAL CO., LTD., Foshan (CN)

(21) Appl. No.: 13/798,191

(22) Filed: Mar. 13, 2013

(30) Foreign Application Priority Data
Nov. 1, 2012 (CN) 201220570372.4

(51) Int. Cl. E05D 13/00; E05F 11/54

(52) U.S. Cl. CPC E05D 13/00; E05F 11/54
USPC 49/352

(57) ABSTRACT

A shower door pulley device is provided which comprises a pulley seat installed on a movable door; a pulley bracket having at least one pulley and an elastic member; a pressing block to press said elastic member and slidable relative to the pulley seat; a sliding cover slidablely mounted on said pulley seat, supporting the pulley bracket.

### CROSS-REFERENCE TO RELATED APPLICATIONS

The present application claims the benefit of Chinese utility model application No. 201220570372.4 filed on 1 Nov. 2012, the disclosure of which is incorporated herein by reference.

### FIELD OF THE INVENTION

The present invention relates to a shower door and, in particular, to a pulley device used for shower doors, having functions of preventing derailment and reducing vibration.

### BACKGROUND OF THE INVENTION

Shower doors of the state of the art comprise a movable door and a rail. A pulley device is attached to the movable door, sliding within the rail in order to open or close the movable door. However, the pulley device will be easy to jump, or even derail when the shower door is impacted by external force or suddenly locked. In particular, a movable glass door may get cracked when detached from the rail, possibly making people injured and bringing a big potential safety problem. Meanwhile, it entails a lot of time and effort to reinstall the movable door derailed from the rail so that it is inconvenient to be used.

### SUMMARY OF THE INVENTION

An object of the invention is to provide a pulley device used for shower doors, having functions of preventing derailment and reducing vibration.

To achieve the above object, a pulley device used for shower doors is provided, comprising a pulley seat installed on a movable door; a pulley bracket having at least one pulley and an elastic member; a pressing block to press said elastic member and slidable relative to the pulley seat; a sliding cover slidablely mounted on said pulley seat, supporting the pulley bracket.

According to one embodiment of the present invention, the pulley device can be an upper pulley device or a lower pulley device, according to its position in relative to the movable door. At least one pulley of the upper pulley device is hung on an upper rail, with the elastic member of the upper pulley device in the compressed state because of the gravity of the movable door. Then the sliding cover of the lower pulley device is pressed down, driving the pulley bracket to slide down with respect to the pulley seat. The elastic member of the lower pulley device is thus in compressed state, while the at least one pulley of the lower pulley device enters a lower rail.

The elastic member of the lower pulley device will return to its original shape when the press force on the sliding cover of the lower pulley device is withdrawn, so as to support the pulley bracket to slide upward. The at least one pulley of the lower pulley device is therefore engaged within in the lower rail. As a result, the installation of the movable door is finished. When it is necessary to remove the movable door, the sliding cover of the lower pulley device is pressed down, driving the pulley bracket to slide down with respect to the pulley seat, making the at least one pulley of the lower pulley device detached from the lower rail.

Conventionally, the movable door is easy to jump upward when impacted by external force or get suddenly locked. By the present invention, as an elastic member is provided on the pulley bracket and pressed by the pressing block, when the movable door jumps upward due to impact or other reasons, only the pulley seat is driven to move up along with the movable door, while the pulley bracket remains stationary due to the acting force of the elastic member. Therefore, the at least one pulley stays in the rail all the time, so as to prevent the movable door departing from the rail, and to reduce or eliminate the vibration of the movable door.

In one embodiment, the pulley seat is mounted on the movable door by a screw and a nut so that it is convenient for assembly and disassembly and able to guarantee tight, safe and long-term connection.

Preferably, the nut is hexagonal and placed into a hexagonal hole formed on said pulley seat, to make sure that the nut will not rotate and move at all when connecting with the screw.

In another embodiment, a recess is provided on the pulley bracket to receive said elastic member, with an end of the elastic member placed in the recess, to prevent the elastic member from shifting during deformation process. Preferably, the elastic member is a spring.

In one embodiment of the present invention, the pulley bracket is mounted to the pulley seat through a connection means. Said connecting means comprises a sliding pin, a screw and a circlip. The sliding pin is connected with the pressing block with the screw, and the pulley bracket is installed on the pulley seat by the sliding pin, and the sliding pin is fixed by the circlip. The pulley bracket can rotate and slide up and down with respect to the sliding pin. One end of the sliding pin is passed through the elastic member and connected with the pressing block with the screw, and the other end of the sliding pin is passed through the through hole of the pulley bracket and the through hole of the pulley seat and fixed by the circlip.

In another embodiment of the present invention, the pulley bracket is mounted to the pulley seat through a connection means. Said connecting means comprises a screw. The pressing block has a connecting shaft with a screw hole. The connecting shaft is used to install the pulley bracket on the pulley seat, and fixed by the screw. The pulley bracket can rotate and slide up and down with respect to the connecting shaft. The connecting shaft is passed through the elastic member and the through hole of the pulley bracket, and the screw is passed through the through hole of the pulley seat and screwed together with the screw hole of the connecting shaft.

In another embodiment, each of the pulley seat and the sliding cover has a bulge engageable with each other to make sure that the sliding cover will not be detached from the pulley seat when sliding relative to the pulley seat.

In another embodiment, the pulley seat is provided with a decorative cover to cover the pulley seat, providing for an aesthetic appearance.

In another embodiment, two pulleys are arranged on the pulley bracket.

In summary, the present invention is less time-consuming and less labor-intensive to assemble and disassemble the movable door during use. Meanwhile, the pulleys are forced to stay in the rail all the time, so as to prevent the movable door from departing from the rail, and to reduce or eliminate the vibration of the movable door.

### BRIEF DESCRIPTION OF THE DRAWINGS

Further advantages and details of the present invention emerge from the example embodiments described below, which do not limit the invention in any way, and from the drawings, in which

FIG. 1 is an exploded view according to example 1 of the invention;

FIG. 2 is a schematic view of the pulley seat shown in FIG. 1;

FIG. 3 is a schematic view of the pulley bracket shown in FIG. 1;

FIG. 4 is a schematic view of the pressing block shown in FIG. 1;

FIG. 5 is a schematic view of the sliding cover shown in FIG. 1;

FIG. 6 is an assembly view of the FIG. 1;

FIG. 7 is a schematic cross-sectional view of the FIG. 6;

FIG. 8 is a schematic view showing how to use according to example 1 of the invention;

FIG. 9 is another exploded view according to example 1 of the invention;

FIG. 10 is an assembly view of the FIG. 9;

FIG. 11 is a schematic cross-sectional view of the FIG. 10;

FIG. 12 is another schematic view showing how to use according to example 1 of the invention;

FIG. 13 is an exploded view according to example 2 of the invention;

FIG. 14 is a schematic view of the pulley seat shown in FIG. 13;

FIG. 15 is a schematic view of the pressing block shown in FIG. 13;

FIG. 16 is a schematic view of the sliding cover shown in FIG. 13;

FIG. 17 is an assembly view of the FIG. 13;

FIG. 18 is a schematic cross-sectional view of the FIG. 17;

FIG. 19 is a schematic view showing how to use according to example 2 of the invention;

FIG. 20 is another exploded view according to example 2 of the invention;

FIG. 21 is an assembly view of the FIG. 20;

FIG. 22 is a schematic cross-sectional view of the FIG. 21;

FIG. 23 is another schematic view showing how to use according to example 2 of the invention.

Elements that are irrelevant to the spirit of the present invention are omitted for clarity.

### DETAILED DESCRIPTION OF THE INVENTION

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” include any and all combinations of one or more of the associated listed items. It will be further understood that the terms “comprises” “comprising” “includes” and/or “including” when used herein, specify the presence of stated features, integers, steps, operations, elements, and/or components, but do not preclude the presence or addition of one or more other features, integers, steps, operations, elements, components, and/or groups thereof.

### EXAMPLE 1

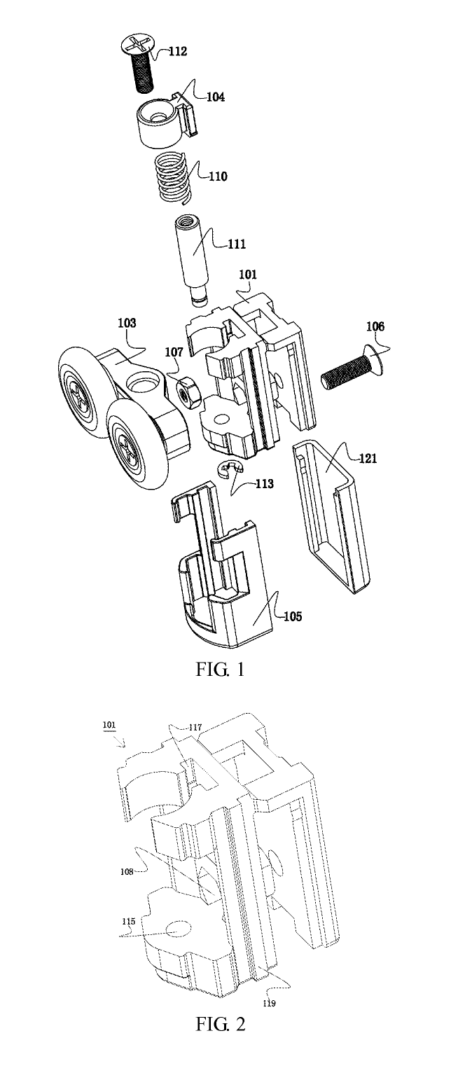

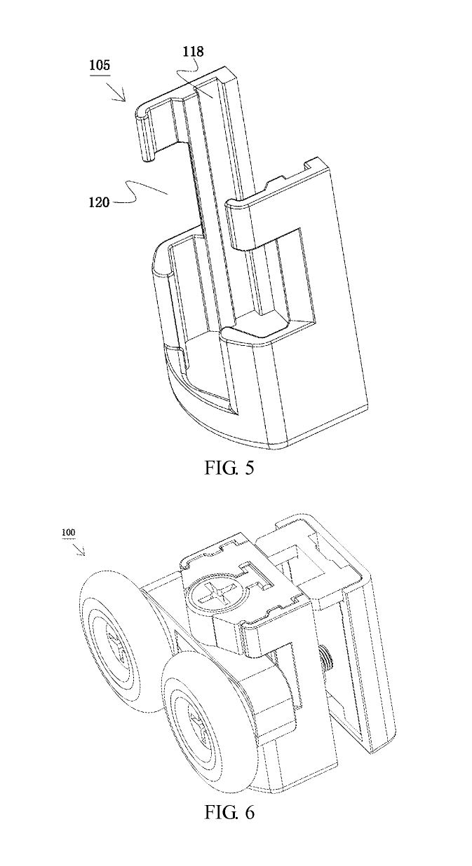

Referring to FIGS. 1 to 5, a pulley device 100 used for shower doors is shown which comprises a pulley seat 101 attached to a movable door; a pulley bracket 103 having at least one pulley 102 and an elastic member; a pressing block 104 to press said elastic member and slidable relative to the pulley seat 101; a sliding cover 105 slidablely mounted on said pulley seat 101, supporting the pulley bracket 103.

As shown in FIGS. 1 and 2, the pulley seat 101 is mounted on the movable door by a screw 106 and a nut 107 so that it is convenient for assembly and disassembly and able to guarantee a tight, safe and long-term connection. In the present example, the nut 107 is hexagonal and placed into a hexagonal hole 108 formed on the pulley seat 101, to make sure that it does not rotate and move during connection with the screw 106.

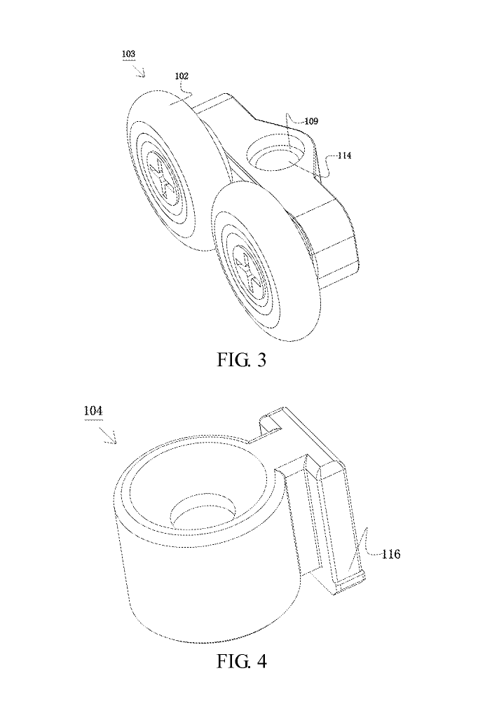

As shown in FIGS. 1 and 3, a recess 109 is provided on the pulley bracket 103 to receive said elastic member, with one end of the elastic member placed in the recess 109, to prevent the elastic member from shifting during deformation. In the present example, the elastic member is a spring 110.

As shown in FIGS. 1 to 4, the pulley bracket 103 is mounted to the pulley seat 101 through a connection means. Said connecting means comprises a sliding pin 111, a screw 112 and a circlip 113. One end of the sliding pin 111 is passed through the spring 110 and connected with the pressing block 104 with the screw 112, while the other end of the sliding pin 111 is passed through the through hole 114 of the pulley bracket 103 and the through hole 115 of the pulley seat 101 and fixed by the circlip 113. The pulley bracket 103 can rotate and slide up and down with respect to the sliding pin 111. The spring 110 is pressed by the pressing block 104. Meanwhile, the slider 116 on the pressing block 104 slides into the groove 117 on the pulley seat 101 and can slide up and down with respect to the groove 117.

As shown in FIGS. 1, 2 and 5, the groove 118 of the sliding cover 105 is slidablely mounted on the slide rail 119 of the pulley seat 101. An opening 120 is arranged on the sliding cover 105 for accommodating the pulley bracket 103.

As shown in FIG. 1, the pulley seat 101 is provided with a decorative cover 121 to cover on at least a part of the pulley seat 101. For example, the screw 106 is covered and concealed by the decorative cover 121 to obtain an esthetic appearance.

In the present example, two pulleys 102 are provided to the pulley bracket 103.

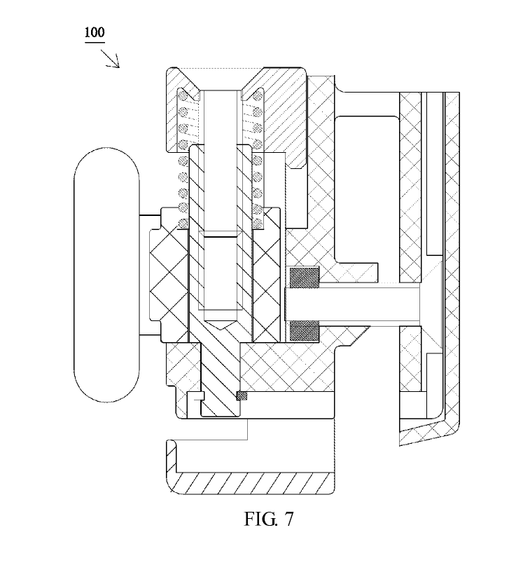

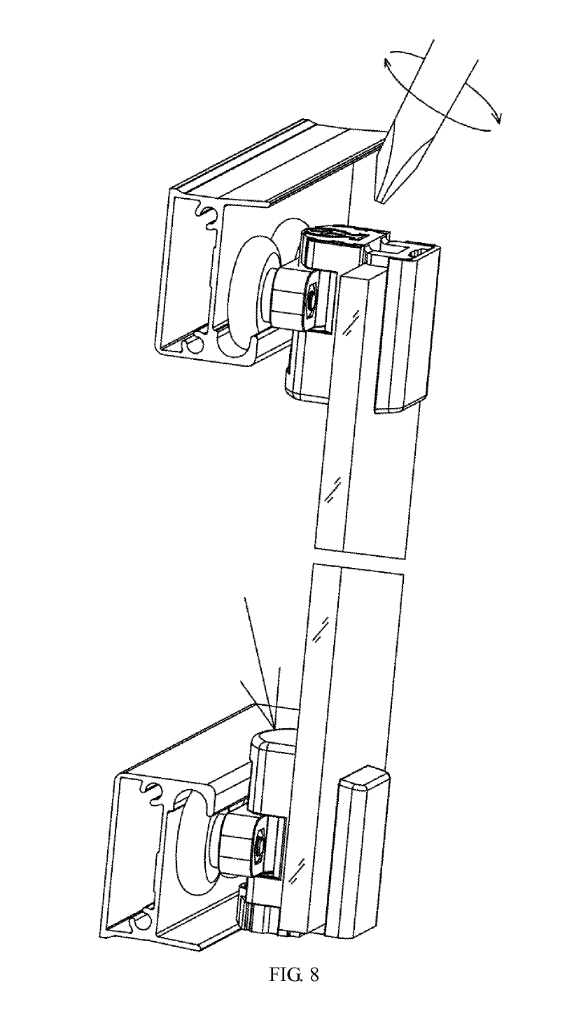

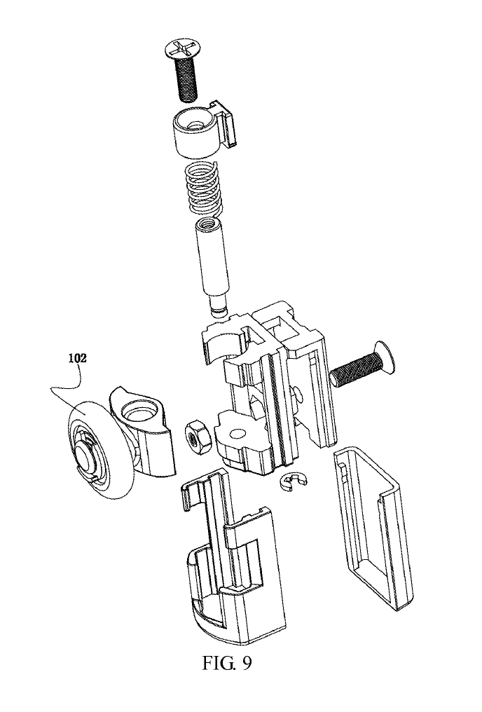

As shown in FIGS. 1, 6 to 8, during use, at least one upper pulley device, more commonly two upper pulley devices, and at least one lower pulley device, more commonly two lower pulley devices, are used. The pulleys 102 of the upper pulley device are hung on the upper rail, with the spring 110 of the upper pulley device in compressed state because of the gravity of the movable door. Then the sliding cover 105 of the lower pulley device is pressed down, driving the pulley bracket 103 to slide down with respect to the pulley seat 101, making the spring 110 of the lower pulley device in compressed state, while the pulleys 102 of the lower pulley device enters the lower rail.

The spring 110 of the lower pulley device will return to its original state when the force applied on the sliding cover 105 of the lower pulley device is withdrawn, so as to support the pulley bracket 103 to slide upward. The pulleys 102 of the lower pulley device are firmly engaged in the lower rail. As a result, the installation of the movable door is finished. When it is necessary to remove the movable door, the sliding cover 105 of the lower pulley device is pressed down, driving the pulley bracket 103 to slide down with respect to the pulley seat 101, making the pulleys 102 of the lower pulley device apart from the lower rail.

As a spring 110 is provided on the pulley bracket 103 and pressed by the pressing block 104 in the invention, when the movable door is actuated to jump, the pulley bracket 103 remains stationary under the effect of the spring 110, and only the pulley seat 101 is driven by the movable door to slide up with respect to the pulley bracket 103, and the pulleys 102 stay in the rail all the time, so as to prevent the movable door from departing from the rail, and to reduce or eliminate the vibration of the movable door.

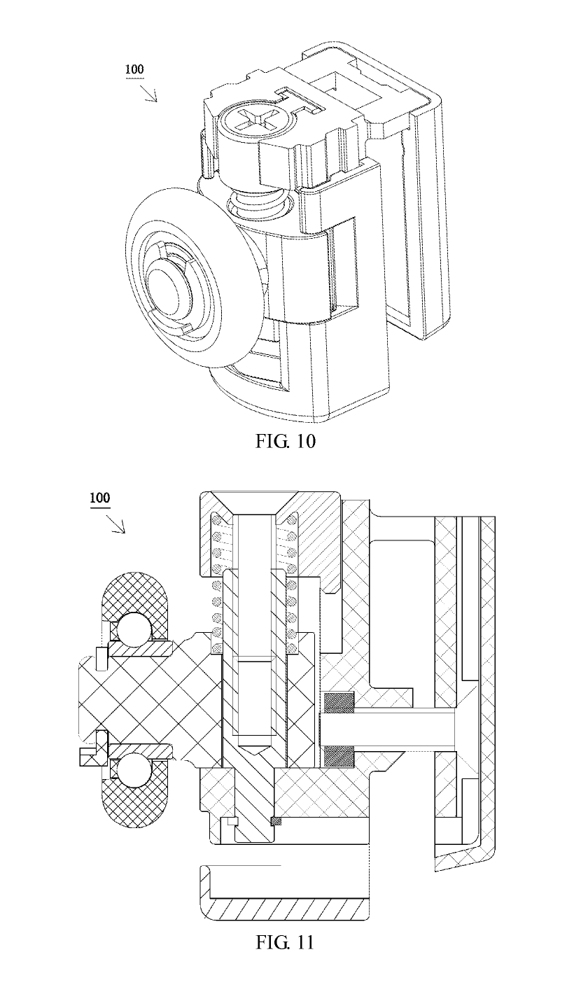

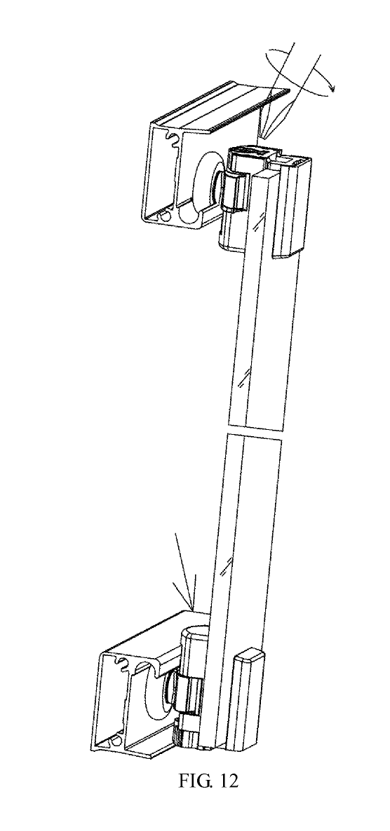

As shown in FIGS. 9 to 12, only one pulley 102 can also be arranged on the pulley bracket 103.

### EXAMPLE 2

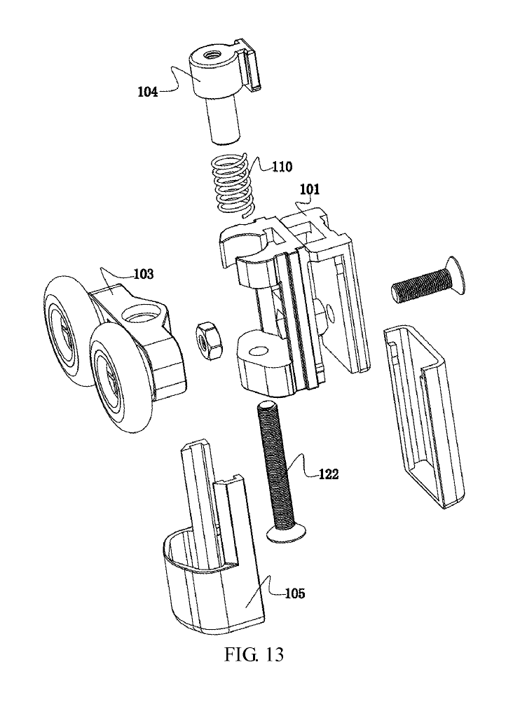

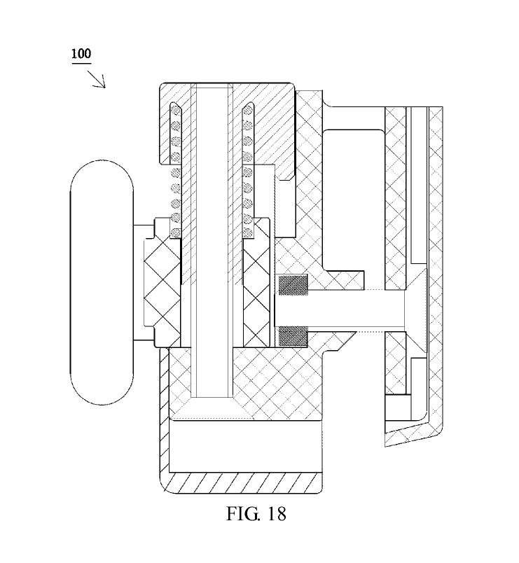

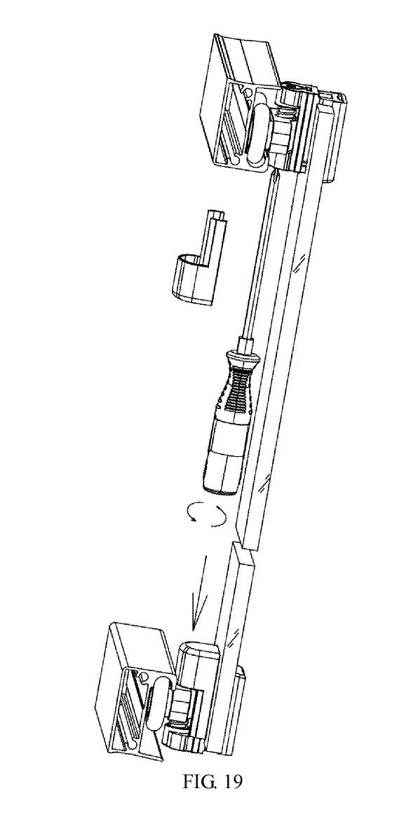

As shown in FIGS. 13 to 19, the present example is substantively equal to example 1 except that the connecting means comprises a screw 122. A connecting shaft 124 with a screw hole 123 is formed on the pressing block 104. The connecting shaft 124 is passed through the spring 110 and then the through hole 114 of the pulley bracket 103, and the screw 122 is passed through the through hole 115 of the pulley seat 101 and screwed together with the screw hole 123 of the connecting shaft 124. The pulley bracket 103 can rotate and slide up and down with respect to the connecting shaft 124. The spring 110 is pressed by the pressing block 104. Meanwhile, the slider 116 on the pressing block 104 slides into the groove 117 on the pulley seat 101 and can slide up and down with respect to the groove 117.

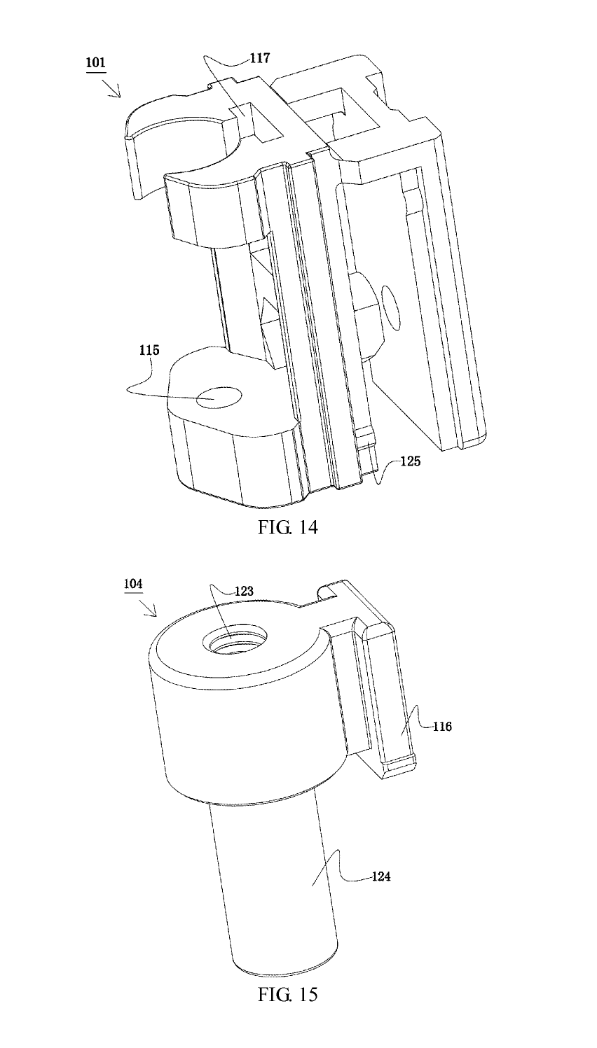

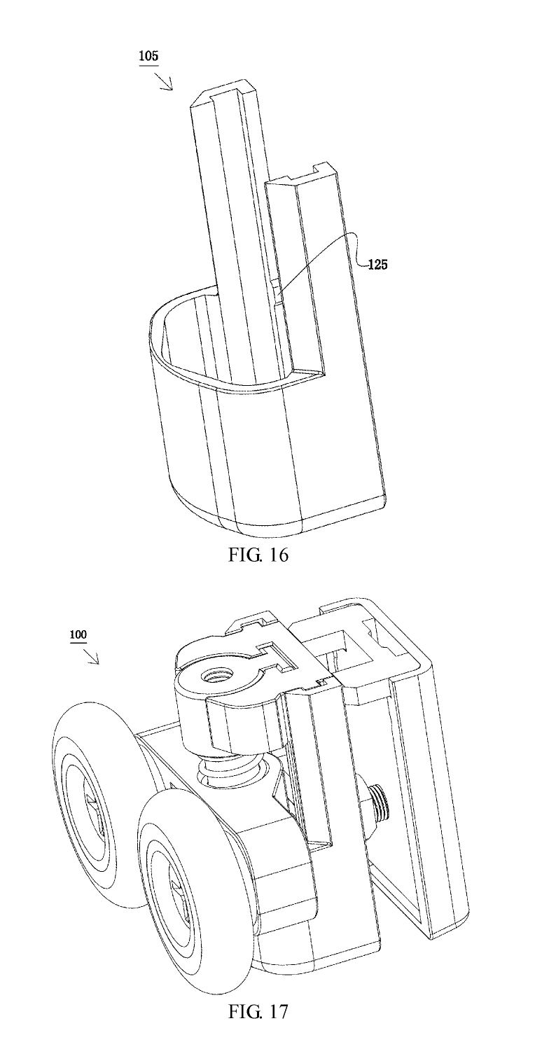

As shown in FIGS. 14 and 16, a bulge 125 is provided on the pulley seat 101 and the sliding cover 105 respectively, abutting against with each other to make sure that the sliding cover 105 does not detach from the pulley seat 101 when sliding relative to the pulley seat 101.

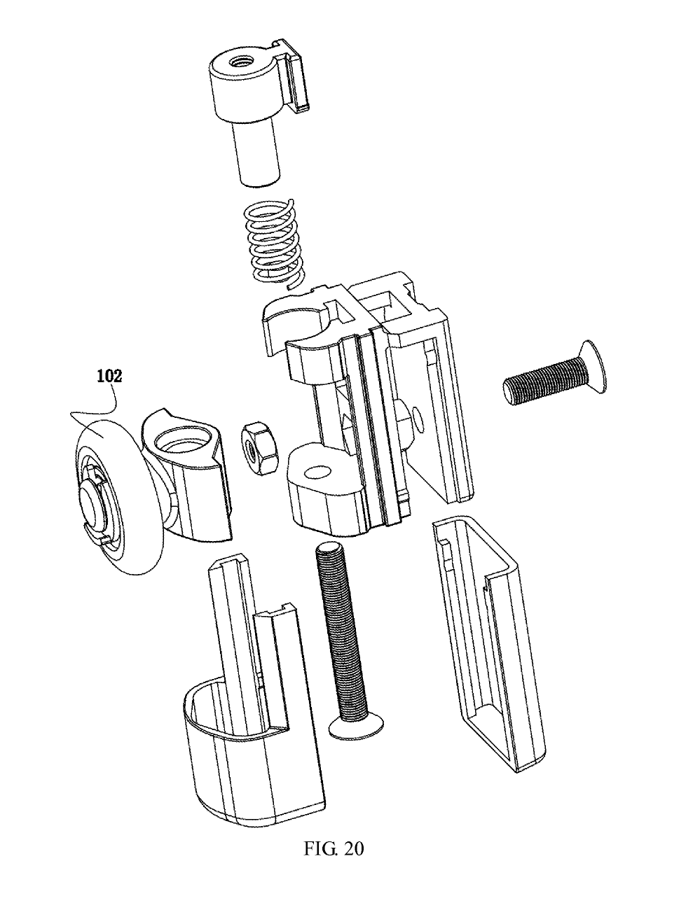

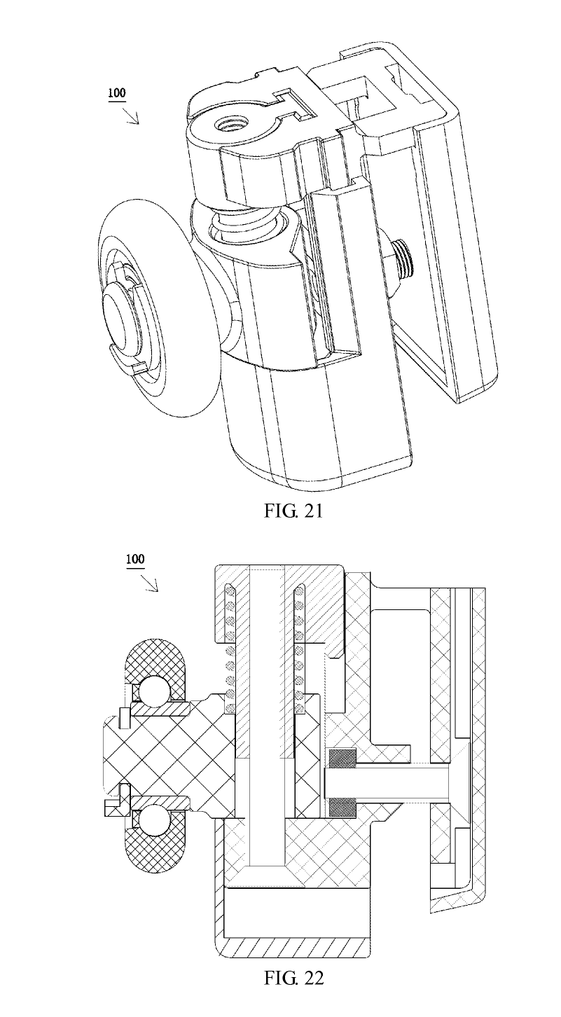

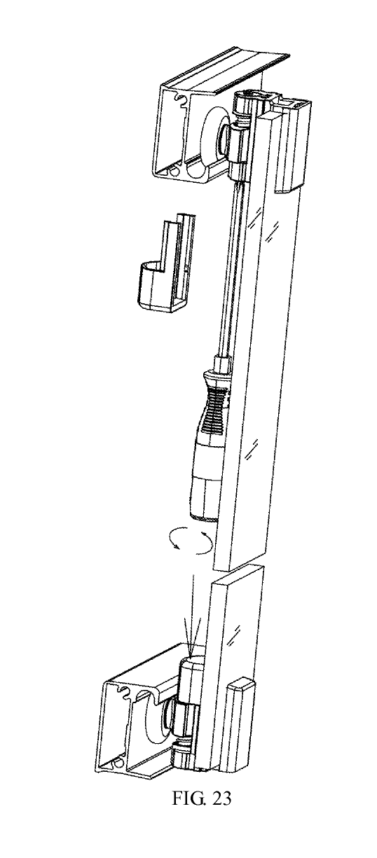

As shown in FIGS. 20 to 23, only one pulley 102 can also be arranged on the pulley bracket 103.

It should be understood that various example embodiments have been described with reference to the accompanying drawings in which only some example embodiments are shown. The present invention, however, may be embodied in many alternate forms and should not be construed as limited to only the example embodiments set forth herein.

What is claimed is:

1. A shower door pulley device, comprising
a pulley seat installed on a movable door;
a pulley bracket having at least one pulley and an elastic member;
a pressing block to press said elastic member and slidable relative to the pulley seat; and
a sliding cover slidablely mounted on said pulley seat, supporting the pulley bracket.

2. The shower door pulley device of claim 1, wherein said pulley seat is mounted on the movable door by a screw and a nut.

3. The shower door pulley device of claim 2, wherein said nut is hexagonal and placed into a hexagonal hole formed on said pulley seat.

4. The shower door pulley device of claim 1, wherein a recess is provided on said pulley bracket to receive said elastic member.

5. The shower door pulley device of claim 1, wherein said elastic member is a spring.

6. The shower door pulley device of claim 1, wherein the pulley bracket is mounted to the pulley seat through a connection means, said connecting means comprising a sliding pin, a screw and a circlip, said sliding pin being connected with the pressing block with the screw, said pulley bracket being installed on the pulley seat by the sliding pin, the sliding pin being fixed by the circlip, and the pulley bracket being able to rotate and slide up and down with respect to the sliding pin.

7. The shower door pulley device of claim 1, wherein said connecting means comprise a screw, and said pressing block has a connecting shaft with a screw hole, the connecting shaft being used to install the pulley bracket on the pulley seat and fixed by the screw, and the pulley bracket being able to rotate and slide up and down with respect to the connecting shaft.

8. The shower door pulley device of claim 1, wherein each of the pulley seat and the sliding cover has a bulge engageable with each other.

9. The shower door pulley device of claim 1, wherein said pulley seat is provided with a decorative cover.

10. The shower door pulley device of claim 1, wherein two pulleys are arranged on the pulley bracket.
